(19) United States
(12) Patent Application Publication
(10) Pub. No.: US 2012/0140201 A1
(43) Pub. Date: Jun. 7, 2012

(54) RANGEFINDER WITH INTEGRATED RED-DOT SIGHT

(76) Inventors: Richard P. Grauslys, Litchfield, NH (US); Stewart P. Johnson, Temple, NH (US); Rick K. Dorval, Dunbarton, NH (US); Dale A. Jancic, Bedford, NH (US)

(21) Appl. No.: 12/054,794

(22) Filed: Mar. 25, 2008

Related U.S. Application Data
(60) Provisional application No. 60/908,209, filed on Mar. 27, 2007.

(51) Int. Cl. G01C 3/08

(52) U.S. Cl. 356/4.01

(57) ABSTRACT

A laser range finder has a first laser oriented in a first direction and a laser range transmitter and a laser range receiver oriented in a second and opposite direction, all mounted on an optical bench. The first laser having a small divergence and used to aim the laser range transmitter and receiver at a target of interest in order to determine the distance to target. The optics and electronics being housed in a housing that can be coupled to a weapon. The housing supporting a plurality of adjustors in contact with the optical bench to align the first laser, the laser range transmitter, and laser range receiver with a scope or iron sights on a weapon.

### CROSS-REFERENCE TO RELATED APPLICATIONS

This application claims the benefit of U.S. provisional patent application Ser. No. 60/908,209 filed Mar. 27, 2007. The entire disclosure of which is incorporated herein by reference in its entirety.

### BACKGROUND OF THE INVENTION

Laser range finders have been used in conjunction with sniper rifles (e.g. Barrett XM-109, Accuracy International Super Magnum L115A1) to determine a distance to target to help the sniper determine how to aim the weapon in order to compensate for ballistic drop. An accurate distance to target is important because a bullet traveling over 800 m can drop in excess of 300″. The range finder may have transmitter optics, receiver optics, and a forward directed visible laser that are coupled to an optical bench that is then coupled to the housing of the range finder. The transmitter optics, receiver optics and forward directed visible laser may be factory coaligned on the optical bench. A set of up-down and left-right adjustors may be used to align the optical bench (using the forward directed visible laser) with either a scope or a set of iron sights on a target at a known distance so the user can point the weapon at the target he wants to range. This alignment ignores ballistic drop.

Instead of using a scope or iron sights, a sniper may combine a weapon mountable laser range finder with a red dot sight to allow the sniper to align the red dot with the target he wishes to range while not revealing his location as would happen with a visible or infrared forward directed laser. Traditional red dot sights use refractive or reflective optics to generate a collimated image of a luminous or reflective reticle. An eye-safe laser beam is projected forward, reflected off of the optics, and then back into the user's eye. This collimated image appears to be projected out to a point at infinity, which makes the image of the reticle appear to the user to be projected onto the target. These red dot sights typically have unity magnification which allows both eyes to be left open, and the eye that sees the reticle image will automatically superimpose that image with the image from the other eye, giving the shooter normal depth perception and full field of view. This makes the red dot sight very fast and easy to use.

These red dot sights may be mounted in their own housing and then mechanically coupled to the range finder. They may have their own set of adjustors to compensate for windage and elevation when coupled to a weapon. A drawback to red dot sights is their size and that coalignment of the red dot with the axis of a range finder can not easily be maintained when there is a set of adjustors for the red dot sight and another set of adjustors for the range finder.

### BRIEF DESCRIPTION OF THE DRAWINGS

For a better understanding of the present invention, together with other objects, features and advantages, reference should be made to the following detailed description which should be read in conjunction with the following figures wherein like numerals represent like parts:

FIG. 1 is an isometric view of a laser range finder consistent with a first embodiment of the invention.

FIG. 2 is an isometric view of the laser range finder of FIG. 1 from a second end.

FIG. 2A is a side view of a weapon with a laser range finder coupled thereto.

FIG. 3 is a system block diagram of the laser range finder of FIG. 1

FIG. 4 is an exposed isometric view of an optical bench in the laser range finder of FIG. 1.

FIG. 5 is an end view of the laser range finder of FIG. 1.

### DETAILED DESCRIPTION

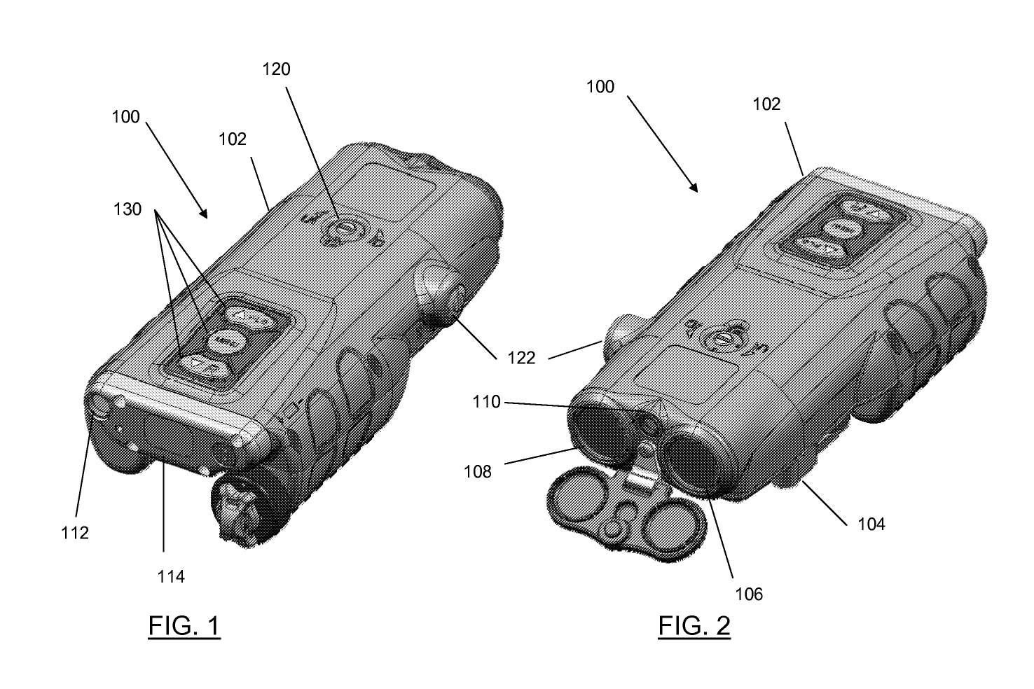

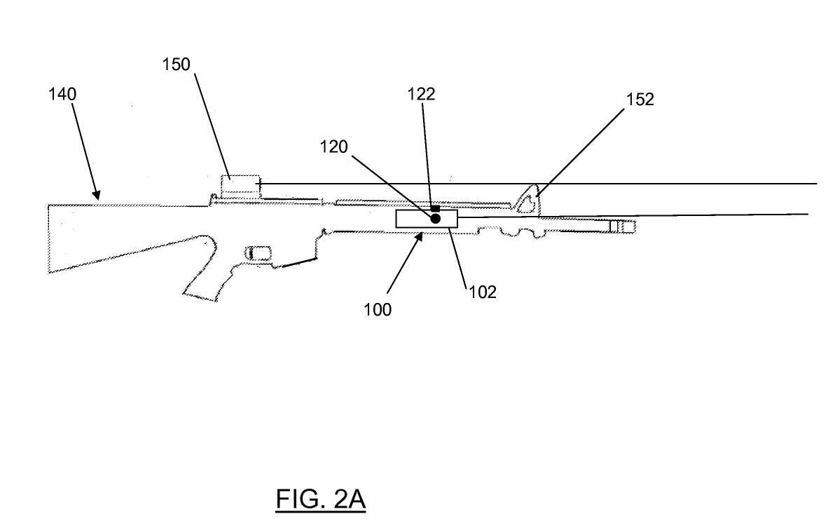

FIG. 1 is an isometric view from a first end of a laser range finder 100 consistent with a first embodiment, FIG. 2 is an isometric view from a second end of the laser range finder 100, and FIG. 2A is a side view of a weapon with a laser range finder coupled thereto. The optics, mechanical components and electronics may at least be partially enclosed within the housing 102. The housing 102 may be removable coupleable to a weapon 140 with a suitable attachment mechanism 104, for example a rail grabber, slide-lock mechanism, or other clamp. The laser range finder 100 may have a red dot laser 112 and a display 114, for example an LCD display on a user's end and transmitter optics 106, receiver optics 108 and a boresight laser 110 on an opposite end. The red dot laser 112 and the boresight laser 110 may be visible, having a wavelength of around 635-650 nm. Lasers having different wavelengths may be used without departing from the scope of the invention. Alternatively, a generally collimated light beam from a non-laser light source may be used to project a generally non-diverging light beam towards the user to assist in aligning the transmitter and receiver optics with a target, for example an LED spaced from a pin-hole aperture may be used. The laser range finder may have a plurality of switch actuators 130 to control operation.

When the laser range finder is coupled to a weapon 140 as shown in FIG. 2A, a left-right adjustor 120 and an up-down adjustor 122 may be used to align the transmitter optics 106, receiver optics 108 and the boresight laser 110 with a reticle in a scope 150 or with iron sights 152. Alternatively, electrically controllable actuators may be substituted for the mechanical adjustors. The electrically controllable actuators may be a micro-electro-mechanical system (MEMS). A MEMS may be an integration of mechanical elements, optical elements, sensors, actuators, and electronics on a semi-conductor, e.g., silicon substrate through microfabrication technology. While the electronics may be fabricated using integrated circuit (IC) process sequences (e.g., CMOS, Bipolar, or BICMOS processes), the micromechanical components may be fabricated using compatible “micromachining” processes that selectively etch away parts of the silicon wafer or add new structural layers to form the mechanical and electromechanical devices. The laser range finder may be mounted on top of the weapon without departing from the scope of the invention.

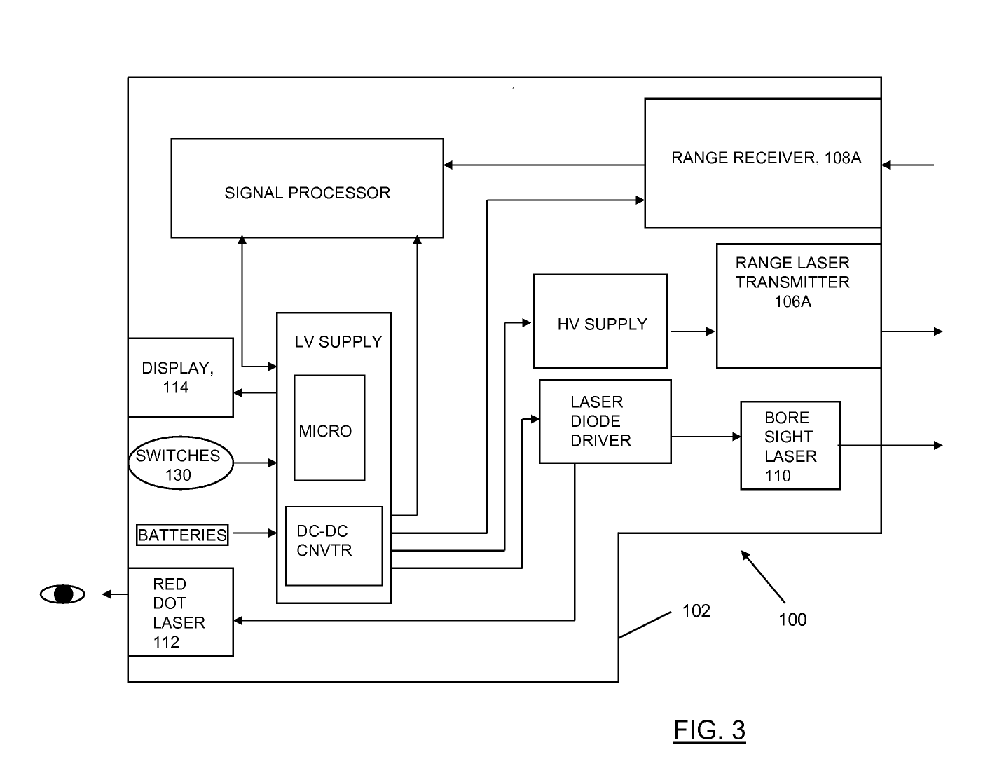

FIG. 3 is a system block diagram of the laser range finder 100. The range laser transmitter 106A sends a signal out of the front end of the laser range finder 100 and receives the reflected signal with a range receiver 108A and the distance to target information is calculated in a signal processor and displayed in the display 114.

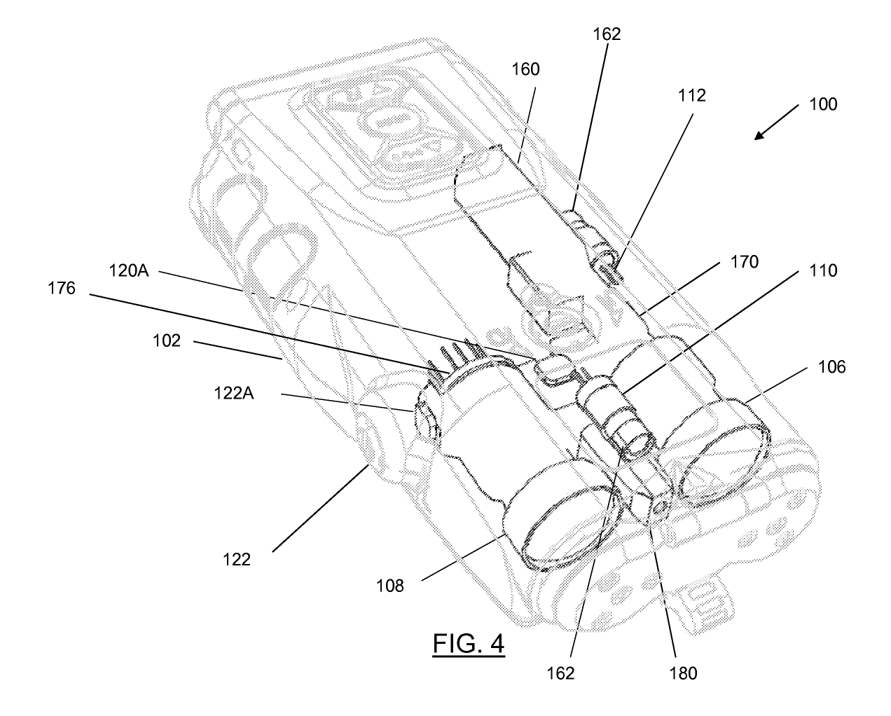

FIG. 4 is an exposed isometric view of an optical bench in the laser range finder 100. The transmitter optics 106, receiver optics 108, red dot laser 112, and boresight laser 110 may be mounted on a common optical bench 170 and factory aligned, typically at infinity. A laser detector assembly 176 may be located behind the receiver optics 108 and a monoblock laser assembly and a pump cavity cover assembly 160 may be located behind the transmitter optics 106. The optical bench 170 may be made of plastic or metal, for example, aluminum. The optical bench 170 may be coupled to the housing 102 through a flexure 180 which may allow the optical bench to be steered by the adjustors 120, 122. A Risley lens pair 162 may be aligned with the red-dot laser 112 and the borelight laser 110 to focus and align the lasers 112, 110. The red dot laser 112 may have a divergence of approximately 0.5 mRad and have an average power of ˜50 nW. Adjustor pads 120A, 122A may be inserted between the mechanical screws of the adjustors 120, 122 and the optical bench 170. Since the transmitter optics 106, receiver optics 108, the red dot laser 112, and boresight laser 110 are all mounted on the common optical bench 170, they will be steered together by the adjustors.

When the laser range finder 100 is mounted on the weapon 140 and the transmitter optics 106 and receiver optics are aligned with either the scope 150 or the iron sights 152, the user simply aligns either the scope or the iron sights with the target to be ranged and actuates one of the switches 130 to acquire the range. The distance to target will be displayed on the user's end of the laser range finder in the display 114.

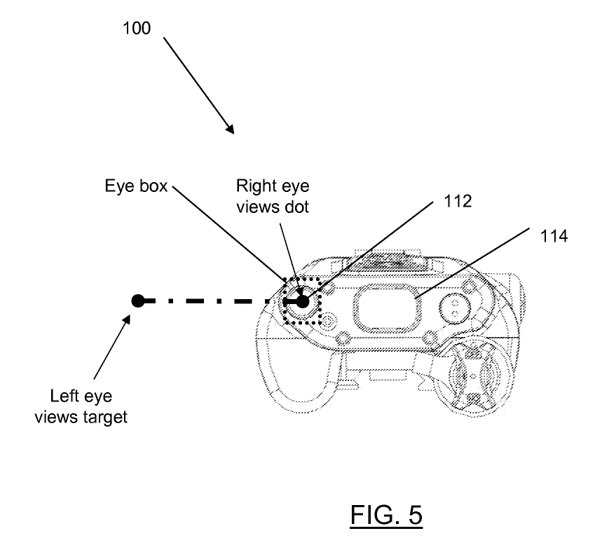

Alternatively as shown in FIG. 5, a user may utilize the laser range finder 100 when it is not coupled to a weapon. Since the axis of the transmitter optics 106 and the receiver optics 108 are on the same optical bench, any misalignment of the optical bench 170 relative to the housing 102 could prevent accurate use of mechanical sights on the laser range finder 100 to sight on a target of interest. The user may hold the laser range finder 100 up with their right eye aligned with the red-dot laser 112 and their left eye locked on a target of interest to determine the distance to target. Direct viewing of the target of interest with the right eye is blocked by the laser range finder 100 and therefore, aiming of the laser range finder 100 may require the operator to keep both eyes open. The red dot laser 112 has a small divergence (<1.5 mRad), so the laser beam will only be visible if the user's eye is properly aligned with the red dot laser beam within a small eyebox. When the laser range finder is hand held at a distance of approximately 1 foot from the user's eye, the eyebox may be as small as 0.15″. Increasing or decreasing the divergence of the red dot laser may be considered within the scope of the invention.

Although several embodiments have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

1. A laser range finder, comprising:
a housing for at least partially enclosing mechanical and electrical components and optics;
a first light source configured to generate a first generally collimated light beam that extends out a first end of the housing;
a laser range receiver;
a laser range transmitter configured to project a signal out a second end of the housing for receipt by the receiver; and
an optical bench configured to hold the first light source, the laser range transmitter and the laser range receiver, the first generally collimated light beam and the laser range transmitter being coaligned.

2. The laser range finder of claim 1, wherein the first light source is a first laser diode.

3. The laser range finder of claim 2, further comprising a second light source configured to generate a second generally collimated light beam that extends out a [the] second end of the housing, the second light source being a second laser diode that is coupled to the optical bench.

4. The laser range finder of claim 1, further comprising signal processing electronics coupled to the laser range receiver for determining a distance to target.

5. The laser range finder of claim 3, wherein the first generally collimated light beam and the second generally collimated light beam are in the visible spectrum.

6. The laser range finder of claim 3, wherein the first generally collimated light beam and the second generally collimated light beam have a divergence of less than 1 mRad.

7. The laser range finder of claim 2, further comprising a first adjustor for steering the optical bench in a first direction and a second adjustor for steering the optical bench in a second and generally perpendicular direction.

8. The laser range finder of claim 1, further comprising a first electrically controllable actuator for steering the optical bench in a first direction and a second electrically controllable actuator for steering the optical bench in a second and generally perpendicular direction.

9. The laser range finder of claim 8, wherein the electrically controllable actuator is a MEMS.

10. The laser range finder of claim 1, further comprising a display coupled to the housing for projecting distance to target information [towards the first end] for viewing by a user.

11. The laser range finder of claim 1, further comprising a flexure for coupling the optical bench to the housing.

12. The laser range finder of claim 7, wherein the first and second adjustors cause the first laser diode, the laser range transmitter, and the laser range receiver to move as a group.

13. (canceled)

14. The laser range finder of claim 3, wherein the first generally collimated light beam [laser diode], the second first generally collimated light beam [laser diode], and the laser range transmitter are coaligned.

15. An optical bench assembly, comprising:
a first laser diode configured to generate a first generally collimated light beam in a first direction;
a laser range receiver;
a laser range transmitter configured to project a signal in a second direction for receipt by the receiver; and
an optical bench configured to hold the first laser, the transmitter, and the receiver, the generally collimated light beam and the laser range transmitter being coaligned.

16. The optical bench assembly of claim 15, further comprising a second laser diode coupled to the optical bench and configured to generate a second light beam that extends in the second direction.

17. The optical bench assembly of claim 16, wherein the first light beam and the second light beam are in the visible spectrum.

18. The optical bench assembly of claim 16, wherein the first light beam and the second light beam have a divergence of less than 1 mRad.

19. The optical bench assembly of claim 15, further comprising a first adjustor for steering the optical bench in a first direction and a second adjustor for steering the optical bench in a second and generally perpendicular direction.

20. The optical bench assembly of claim 15, further comprising a first electrically controllable actuator for steering the optical bench in a first direction and a second electrically controllable actuator for steering the optical bench in a second and generally perpendicular direction.

21. The optical bench assembly of claim 20, wherein the electrically controllable actuator is a MEMS.

22. The optical bench assembly of claim 19, wherein the first and second adjustors cause the first laser diode, the laser range transmitter, and the laser range receiver to move as a group.

23. The optical bench assembly of claim 19, further comprising a second laser diode configured to generate a second light beam that extends in the second direction, wherein the first and second adjustors cause the first laser diode, the second laser diode, the laser range transmitter, and the laser range receiver to move as a group.

24. (canceled)

25. The optical bench assembly of claim 23, wherein the first generally collimated light beam [laser diode], the second first generally collimated light beam [laser diode], and the laser range transmitter are coaligned.
